(19) United States
(12) Patent Application Publication
(10) Pub. No.: US 2015/0262281 A1
(43) Pub. Date: Sep. 17, 2015

(54) SYSTEM FOR FACILITATING UPGRADES IN CUSTOMER PREMISES

(71) Applicant: Verizon Patent and Licensing Inc., Basking Ridge, NJ (US)

(72) Inventors: Muhammed Shaphy, Irving, TX (US); Jagannath K. Rangarajan, Irving, TX (US); Sanjeev Sati, Wesley Chapel, FL (US); Sundaresan Gnanasekaran, Bharathi Nagar (IN)

(73) Assignee: Verizon Patent and Licensing Inc., Basking Ridge, NJ (US)

(21) Appl. No.: 14/204,034

(22) Filed: Mar. 11, 2014

(51) Int. Cl. G06Q 30/06

(52) U.S. Cl. CPC G06Q 30/0631

(57) ABSTRACT

A system may include an upgrade server device configured to: establish a session with a user device over a network; receive, from the user device during the session, a request to provide a list of recommended upgrades for a customer; obtain the list of recommended upgrades for the customer; send the list to the user device; and receive, from the user device, an order for one of the recommended upgrades in the list. The system may also include a provisioning system configured to provision a product or service associated with the order.

### BACKGROUND

For many telecommunications service providers, field technicians serve as more than mere expert troubleshooters. While interacting with a customer during installation, maintenance, and troubleshooting, a field technician may establish a rapport with the customer.

### BRIEF DESCRIPTION OF THE DRAWINGS

FIG. 1 illustrates concepts described herein according to one implementation;

FIG. 2A shows an exemplary network in which the concepts described herein may be implemented;

FIG. 2B shows exemplary application programming interfaces (APIs) invoked by the exemplary mobile device of FIG. 2A;

FIG. 2C shows exemplary components of the exemplary upgrade support system of FIG. 2A according to one implementation;

FIGS. 3A and 3B are, respectively, front and rear views of the mobile device of FIG. 2A according to one embodiment;

FIG. 4 shows exemplary components of a network device of FIG. 2A;

FIG. 5 is a flow diagram of an exemplary process associated with upgrading communication speed/bandwidth according to one implementation;

FIG. 6 is a flow diagram of an exemplary process associated with upgrading a particular piece of equipment during repair work according to one implementation;

FIG. 7 is a flow diagram of an exemplary process associated with upgrading a piece of equipment, features, or content service during an installation according to one implementation;

FIG. 8 is a flow diagram of an exemplary process associated with an implicit upgrade according to one implementation;

FIG. 9 is a flow diagram of an exemplary process associated with the upgrade support system of FIG. 2C; and

FIG. 10 is a diagram illustrating function calls between the devices or components of the upgrade support system of FIG. 2C.

### DETAILED DESCRIPTION

The following detailed description refers to the accompanying drawings. The same reference numbers in different drawings may identify the same or similar elements.

As used herein, the term “upsell” may refer to selling, in a customer premises, additional equipment, upgrading equipment, selling/contracting additional service(s), and/or upgrading service(s) in the course of repair, installation, and/or maintenance. The term may also refer to the process of upselling the services/equipment, as well as to the services/equipment that are upsold. In addition, the term “upselling speed” may refer to contracting or coming into an agreement, with a customer, to provide higher network connection bandwidth than that previously agreed to by the customer. As used herein, depending on the context, the term “upgrade” may be used synonymously with the term “upsell,” as defined above.

As used herein, the term “customer premises” may refer to the premises of a customer of a service provider. The service provider may include, for example, communication service provider, content delivery service provider (e.g., a cable company, FiOS™ service provider, etc.), etc.

In the following, a user (e.g., a technician, a field technician, a repair person, etc.) may enter a customer's premises to perform tasks such as, e.g., install equipment, repair a device or network, and/or perform maintenance work. In the course of the user's visit, the user may determine, using a mobile device (e.g., a tablet, laptop, a smart phone, etc.), what products and/or services may be upgraded for the customer. If the customer wants to purchase an upgrade, the user may use the mobile device to order the upgrade, may complete the tasks assigned to the user, and may close out the tasks (e.g., installation task). A backend system in communication with the mobile device may provide necessary support for facilitating the upgrade.

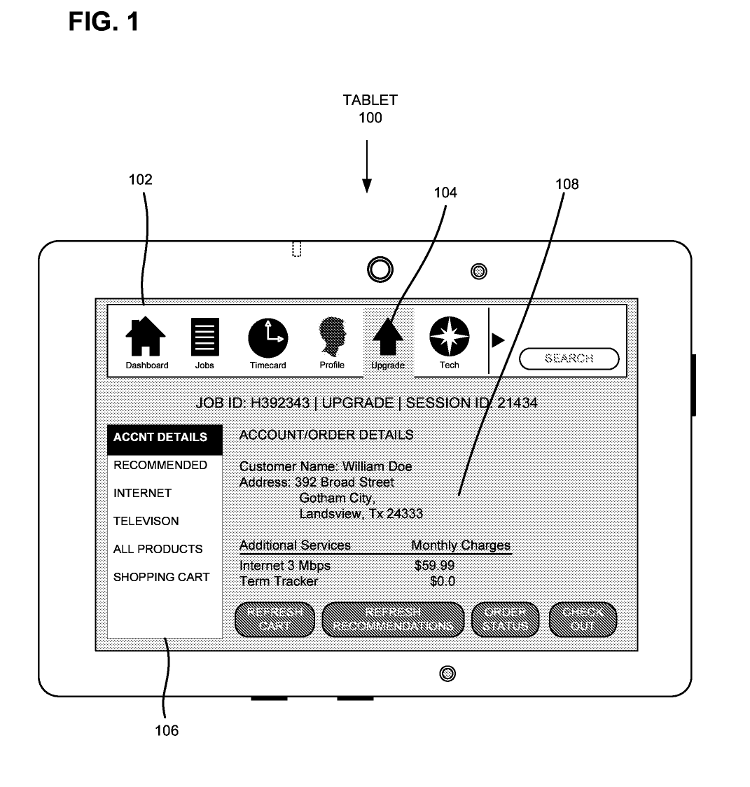

FIG. 1 illustrates concepts described herein according to one implementation. In this implementation, assume that a user (e.g., John) is assigned to repair a device at a customer premises (e.g., Bill's home). Upon arriving at Bill's premises, John accesses a tablet computer 100 (also referred to as “tablet 100”). Via a menu bar 102 on the display of tablet 100, John accesses information about the repair work to be performed at Bill's premises. Before performing the repair work, however, John also activates an upgrade icon 104 on menu bar 102, to view what upgrades John may recommend to Bill.

In this implementation, when John activates the upgrade icon 104, tablet 100 contacts the service provider's network, accesses information that is associated with Bill (e.g., information associated with Bill's account).

As shown in FIG. 1, when John activates upgrade icon 104, tablet 100 displays side menu 106, which includes selectable items, such as an Account Details, Recommended, Internet, Television, and/or All Products menu items. In FIG. 1, the Account Details menu item is already activated, and the display of tablet 100 may show information 108 that is associated with Bill's account (e.g., to what services Bill subscribed, devices that are installed at his premises, etc.). For example, in FIG. 1, tablet 100 shows Bill's account information (e.g., a full legal name, billing address, etc.). In addition, tablet 100 shows that Bill has previously subscribed to the Internet service, which allows Bill to access the Internet at the maximum bit rate of 3 Mega bits per second (Mbps).

Upon viewing Bill's account information, John may activate the Recommended menu item in side menu 106. Activating the Recommended menu item may cause tablet 100 to communicate with a backend system in the service provider network. The system may then provide a list of recommended upgrades to tablet 100. In response, tablet 100 may display the list. For example, tablet 100 may indicate that Bill may upgrade to 5 Mbps Internet service (not shown in FIG. 1).

In FIG. 1, activating the Internet menu item, Television menu item, and/or All Products menu item, etc., may cause tablet 100 to display information related to, respectively, the Internet service, the television/cable service, and/or all products/services that Bill is subscribed to. For example, activating the Internet menu item may cause tablet 100 to display information pertaining to the Internet service to which Bill is subscribed.

If Bill agrees to upgrade any of the products/services he is subscribed to or has purchased, John may activate, via a GUI component (e.g., a menu item, button, etc.), to place the selected upgrade into a virtual cart (e.g., a list of items that a customer has designated for purchase). If John wishes to view information about any of the upgrades that Bill agreed to purchase, to check the status of an upgrade order, or to complete an upgrade, John may activate one of the buttons shown on the display of mobile device 100: the refresh cart button, refresh recommendations button, order status button, and check out button.

In FIG. 1, because a user (e.g., technician/engineer/repair person, John, etc.) is in the customer premises, the user has an opportunity to interact with the customer face-to-face and establish a level of trust that is not easy to establish in other situations (e.g., a customer calls a call center). A system tailored to facilitate transactions between the user and the customer may be especially effective in allowing the user to generate additional revenues to a service provider for the cusomer.

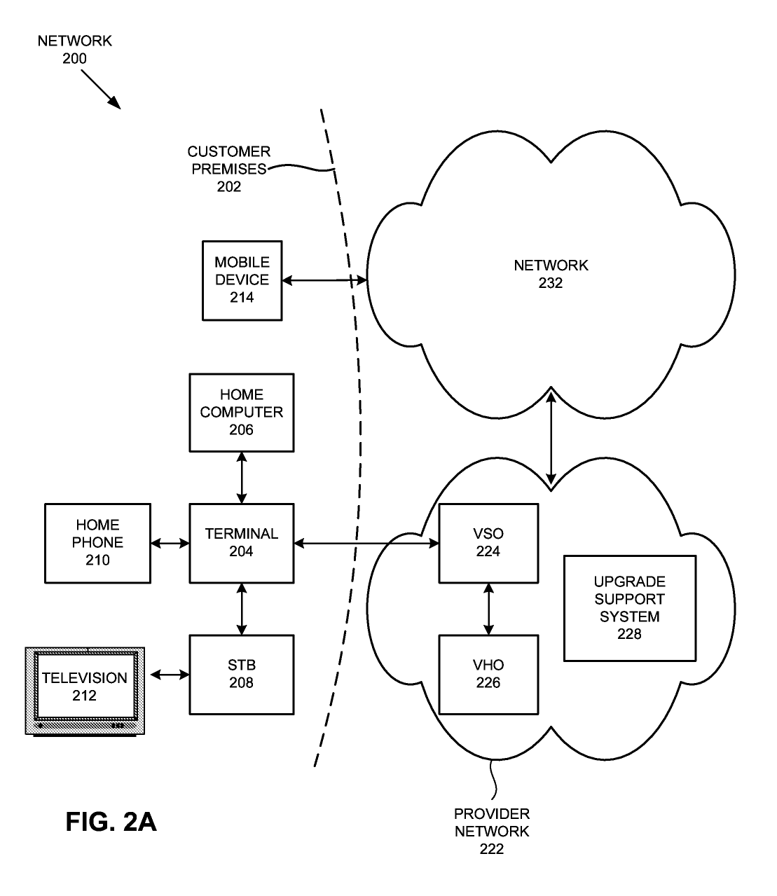

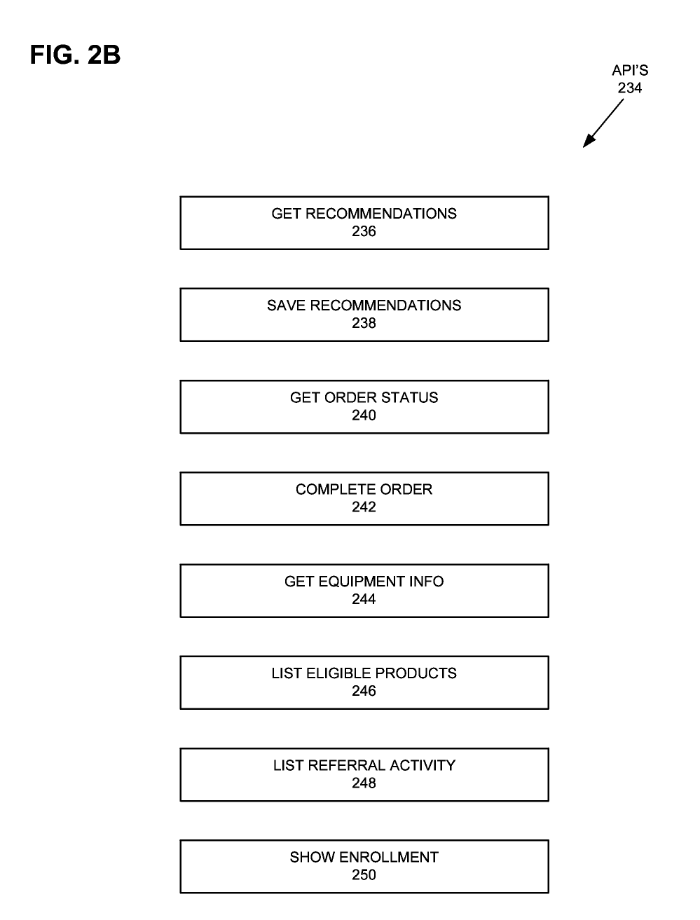

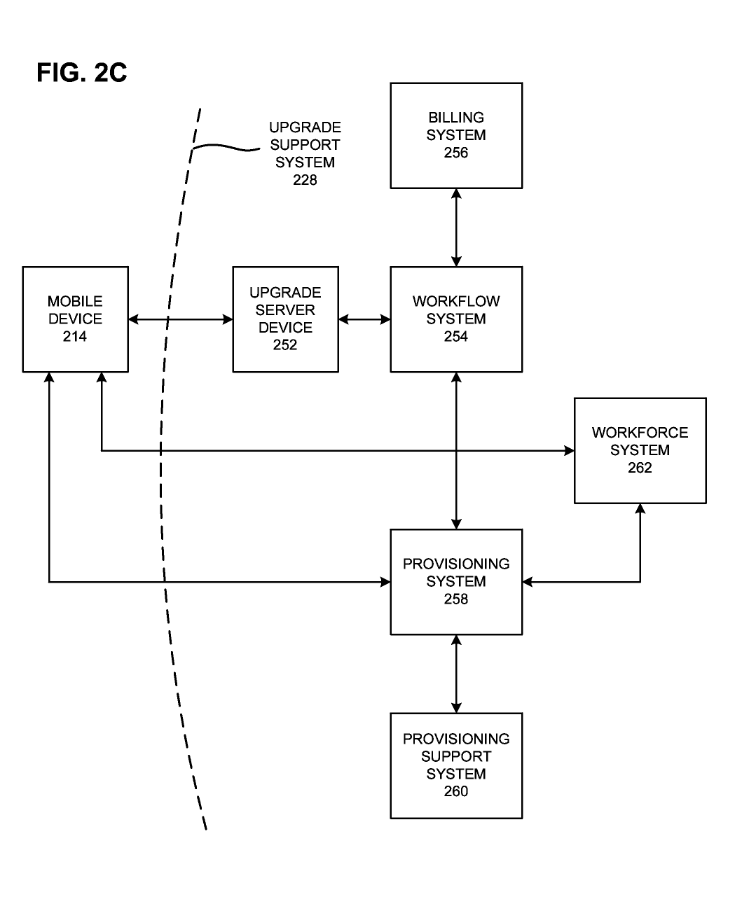

FIG. 2A depicts an exemplary network 200 in which the concepts described herein may be implemented. As shown, network 200 may include customer premises 202, provider network 222, and network 232.

Customer premises 202 (e.g., the customer's home) may include a terminal 204, a home computer 206, a set-top box (STB) 208, a home phone 210, a TV 212, and a mobile device 214. Devices in customer premises 202, such as home computer 206, home phone 210, and TV 210 may each be considered a “customer device.” STB 208 (which may also include a digital video recorder or DVR) may be considered a customer device, if it has been purchased by the customer. Mobile device 214 may be considered a “user device,” which may be conveyed into customer premises 202 by a user (e.g., a field technician, etc.).

Terminal 204 may include a router (not shown) that receives data and may transfer the data to the appropriate device in customer premises 202, such as computer 206 or STB 208. Likewise, the router may receive data from any device in customer premises 202 and may transmit the data to other devices in network 200. The router may provide customer premises 202 with Internet access, television access, or telephone service, for example.

In some implementations, terminal 204 may include devices/components that are passive. Such components may relay signals (e.g., video signals), which are carried by a physical wire (e.g., an optical fiber) into customer premises 202 from provider network 222, to STB 208 or TV 212.

Computer 206 may include a laptop, a desktop, or a portable communication device. STB 208 may receive content and output the content to TV 212 for display. STB 208 may include a component (e.g., a cable card or a software application) that plugs into a host device (e.g., a personal computer, TV 212, a stereo system, etc.) that allows the host device to display content. In some implementations, STB 208 may include functionalities typically associated with other types of devices, such as a DVR. TV 212 may include speakers as well as a display. TV 212 may play content, for example, received from STB 208. Home phone 210 may include a plain old telephone service or POTS telephone or an Internet Protocol (IP) phone, either wireless or wireline.

Mobile device 214 may include a communication device with a display and/or audio I/O components. Examples of mobile device 214 may include a tablet computer (e.g., tablet 100), a laptop computer, a smart phone, etc. Although mobile device 214 is illustrated as being located within customer premises 202, mobile device 214 may be considered a “user device” carried by the user (technician, etc.) into customer premises 202. It is assumed that mobile device 214 is present in customer premises 214 as long as the user is at customer premises 202 to install one or more devices, perform maintenance work, repair a device/network component, etc.

Mobile device 214 may communicate with other devices via one or more communication towers (not shown) using a wireless communication protocol, e.g., GSM (Global System for Mobile Communications), CDMA (Code-Division Multiple Access), WCDMA (Wideband CDMA), IEEE 802.11x, etc. In some implementations, mobile device 214 may be associated with a phone number.

When used during an upgrade, mobile device 214 may make one or more application programming interface (API) calls to other devices in upgrade support system 228. The calls may retrieve information for the user to facilitate an upgrade(s), obtain the status of an order, order the completion of an upgrade, etc.

FIG. 2B lists a number of exemplary APIs 234 that may be invoked by mobile device 214 according to one implementation. As shown, APIs 234 may include Get Recommendations 236, Save Recommendations 238, Get Order Status 240, Complete Order 242, Get Equipment Info 244, List Eligible Products 246, List Referral Activity 248, and Show Enrollment 250. Depending on the implementation, APIs 234 may include additional, fewer, and/or different calls than those illustrated in FIG. 2B.

Get Recommendations 236 may be invoked by mobile device 214 when a user, via mobile device 214, identifies an opportunity to upgrade a product/service and/or initiates upgrading a product/service. An upgrade client installed on mobile device 214 may issue Get Recommendations 236 to upgrade support system 228 over network 200. Upon receiving Get Recommendation 236 from mobile device 214, upgrade support system 228 may replay with a list of products/services that the customer may upgrade to or purchase. Mobile device 214 may receive and display the list.

After viewing the list, the user may recommend possible upgrades to the customer. In some situations, the upgrade client installed on mobile device 214 may provide videos or advertisements that clearly explain the benefits of the upgrades. In such situations, the user may show the videos/advertisements to the customer, to help the customer make informed decisions.

In some implementations, when mobile device 214 issues a Get Recommendation 236 call to upgrade support system 228, upgrade support system 228 may recommend that the customer migrate from its copper wire-based infrastructure to optical fiber infrastructure at no cost to the customer. A copper wire infrastructure can be the source of many technical problems. The user may explain the benefits of upgrading the copper wire-based infrastructure to an optical fiber-based infrastructure to the customer. When the customer agrees to upgrade, the user may place the order via mobile device 214.

In some situations, upgrade support system 228 may also recommend that the customer migrate from its current telephone system to a wireless voice link (e.g., a wireless technology for providing telephone service). If the option to upgrade to voice link is available, the user may convey the benefits of migrating to the voice link and the cost of the upgrade to the customer. If the customer agrees to the upgrade, the user may use mobile device 214 to order the upgrade/upgrade at upgrade support system 228.

Save Recommendations 238 may be issued by mobile device 214 when the user indicates (e.g., via a graphical user interface (GUI)), to the upgrade client on mobile device 214, that the customer is interested in purchasing an upgrade product/service. In response, the upgrade client may save the recommendations for the customer on mobile device 214 and send a notification to upgrade support system 228.

Get Order Status 240 may be issued by mobile device 214 after a Save Recommendations 232 call. After the upgrade client invokes Save Recommendations 238, the user may place an order for the upgrade, via mobile device 214 (e.g., by activating a GUI component on the upgrade client which had previously been installed on mobile device 214), at upgrade support system 228. Upgrade support system 228 may process the order. Thereafter, mobile device 214 may check the status of the order by issuing a Get Order Status 240 call to upgrade support system 228. In response, upgrade support system 228 may provide a confirmation that: the order has been saved in the system; the order is being processed; or the order has been processed. Mobile device 214 may display, e.g., on the GUI, the response from upgrade support system 228.

Complete Order 242 may be issued by mobile device 214 to upgrade support system 228, to order one or more upgrades. When the upgrade client invokes Complete Order 242 to upgrade support system 228, upgrade support system 228 may store a description of workflow corresponding to the order in its database. Upgrade support system 228 may use the description to to initiate and execute one or more tasks for provisioning services/products specified by the order.

Get Equipment Info 244, when issued by mobile device 214, may cause upgrade support system 228 to retrieve information for each item in the entire list of equipment that may be installed at customer premises 202. Upgrade support system 228 may determine the list of equipment based on services/products that are available at customer premises 202 and customer preferences.

List Eligible Products 246, when issued by mobile device 214, may retrieve a list of products (services or equipment, whose upgrade involves an incentive for the user (e.g., a bonus), from upgrade support system 228. The upgrade client may display the list on mobile device 214.

List Referral Activity 248, when issued by mobile device 214, may retrieve a list of all products, which may be upsold, from upgrade support system 228.

Show Enrollment 250, when issued by mobile device 214, may retrieve performance information (e.g., metric), for all the upgrade activity of the user over a specific time period, from upgrade support system 228. The information may aid the user in evaluating the user's activities at customer premises.

In some implementations, when mobile device 214 invokes Get Recommendations 236, upgrade support system 228 may determine a list of recommended upgrade products/services based on the customer's viewing habits or history of using devices in customer premises 202. For example, in one implementation, upgrade support system 228 may recommend a speed upgrade if the customer hits the maximum download/upload rates for longer than a specified threshold. In another example, upgrade support system 228 may recommend upgrading a set-top box 208 if the customer has used more than a specified amount (e.g., a threshold) of storage space on set-top box 208. In making such recommendations, upgrade support system 228 may access STB 208 in customer premises 202, to retrieve data stored thereon. The data may include the customer's viewing history or indicate the customer's viewing habits.

Returning to FIG. 2A, provider network 222 may provide wireless/wired network and/or content services to customer premises 202 and/or stand-alone mobile devices. Provider network 222 may include one or more portions of public switched telephone networks (PSTNs) or another type of switched network (e.g., an optical network). Network 222 may also include a number of transmission towers (not shown) for receiving wireless signals and forwarding the signals toward the intended destination. Network 222 may further include one or more packet switched networks, such as an Internet protocol (IP) based network, a local area network (LAN), a wide area network (WAN), a personal area network (PAN), an intranet, or another type of network (e.g., a satellite-based network) that is capable of exchanging information.

As further shown in FIG. 2A, provider network 222 may include Video Serving Office (VSO) 224, Video Hub Office (VHO) 226, and an upgrade support system 228. VSO 224 may deliver content to customer premises 202 and may receive data from customer premises 202 for forwarding to the proper destination (e.g., upgrade support system 228). VSO 224 may include a content server for transcoding and multiplexing content from different sources for delivery to customer premises 202. VHO 226 may provide on-demand content or may serve and manage interactive content (e.g., a form of content with which a user can interact).

Upgrade support system 228 may include one or more backend devices (e.g., servers) that provide user interfaces (e.g., web pages, cascading style sheets (CSSs), scripts, images, videos, audios, etc.) and/or data to support the user in upgrading a product or service. Upgrade support system 228 is described below in greater detail with reference to FIG. 2C.

Network 232 may be similar to provider network 222 and may include devices similar to those included in provider network 222. In addition, network 232 may include one or more public networks, such as the Internet.

In FIG. 2A, network 232, in conjunction with devices/components in provider network 222, may allow devices at customer premises 202 (e.g., a computer 206, STB 208, and/or mobile device 214) to connect to other devices also attached to network 222/232, such as devices in upgrade support system 228.

Network 200 and devices in network 200 are illustrated as shown for purposes of simplicity of presentation. Depending on the implementation, network 200 may include more devices, fewer devices, or a different configuration of devices than those illustrated in FIG. 2A. For example, network 200 may include thousands or millions of customer premises. In some embodiments, the functions performed by two or more devices may be performed by any one device. Likewise, in some embodiments, the functions performed by any one device may be performed by multiple devices. Further, the connections shown in FIG. 2A are exemplary. In other embodiments, additional connections that are not shown in FIG. 2A may exist between devices (e.g., each device may be connected to every other device). The connections in FIG. 2A may also be wireless or wired.

FIG. 2C shows exemplary components and/or devices of upgrade support system 228 in communication with mobile device 214 via network 232 (network 232 not shown in this Fig.). As shown, upgrade support system 228 may include an upgrade server device 252, a workflow system 254, a billing system 256, a provisioning system 258, a provisioning support system 260, and a workforce system 262. Depending on the implementation, upgrade support system 228 may include additional, fewer, different, or a different arrangement of components and devices than those illustrated in FIG. 2C. For example, in some implementations, upgrade support system 228 may include additional billing systems, upgrade server devices, provisioning systems, etc. In other implementations, a single system may include the functionalities of multiple systems illustrated in FIG. 2C.

Upgrade server device 252 may receive API calls, from mobile device 214, that request information, request change orders, and/or place additional orders. Upon receipt of API calls from mobile device 214, upgrade server device 252 may either access other systems and databases to obtain the requested information or push orders/change orders to workflow system 254.

Workflow system 254 may receive the orders from upgrade server device 252 and store information pertaining to the order as a workflow description. The description may be stored in a database (not shown) and may be used to drive provisioning system 258.

For example, if an order requires provisioning multiple devices, workflow system 254 may store the order as a workflow description. The workflow description may specify provisioning the devices in an appropriate sequence. Furthermore, in accordance with the description, workflow system 254 may drive provisioning system 258 to provision specific services and/or equipment in the specified sequence.

When workflow system 254 receives a messagem from provisioning system 258 (via workforce system 262, mobile device 214 and upgrade server device 252), that a particular product/service has been provisioned, workflow system 254 may determine whether the provisioning also fills an existing order. If so, workflow system 254 may send information to billing system 256, indicating that the order has been filled. Otherwise, workflow system 254 may continue to provision other products/services required to fill the order.

Billing system 256 may receive information from workflow system 254 regarding an order (e.g., services/products that have been provisioned). Based on the information, billing system 256 may charge a particular customer's account.

Provisioning system 258 may receive a request to provision a particular product/service and attempt to take appropriate steps to provision the product/service. In one implementation, provisioning system 258 may: activate equipment and/or features via provisioning support system 260; and assign the tasks that are associated with the upgrade to workforce system 262 (e.g., send requests to provisioning support system 260 and/or workforce system 262). Upon receipt of replies from provisioning support system 260 and workforce system 262, provisioning system 258 may notify workflow system 254 whether a particular service/produce has been successfully provisioned.

Provisioning support system 260 may activate a product, features, or a piece of equipment. In some implementations, provisioning support system 260 may provide a circuit view of the system at customer premises 202, and may activate a specific device or a component (e.g., a software component on STB 208, increase the storage capacity of STB 208, etc.). Upon activating the device/component, provisioning support system 260 may notify provisioning system 258.

Workforce system 262 may receive, from provisioning system 258, a request to assign one or more tasks to the user. On one hand, if the request involves an upgrade during repair work, a new task may be assigned to the user. The new task, which may be stored as a record in a database, may include an indication that the job has been initiated by the user. On the other hand, if the request involves an upgrade during installation work, provisioning system 258 may not cause workforce system 262 to create a new task or or update an existing record.

When the user completes a particular task (e.g., installations and/or repair work associated with either the original work order or the upgrade order), the user may close out the original/upgrade order. Depending on the implementation, when the user closes out the order, mobile device 214 may send a close-out notification to either upgrade server device 252 or to provisioning system 258.

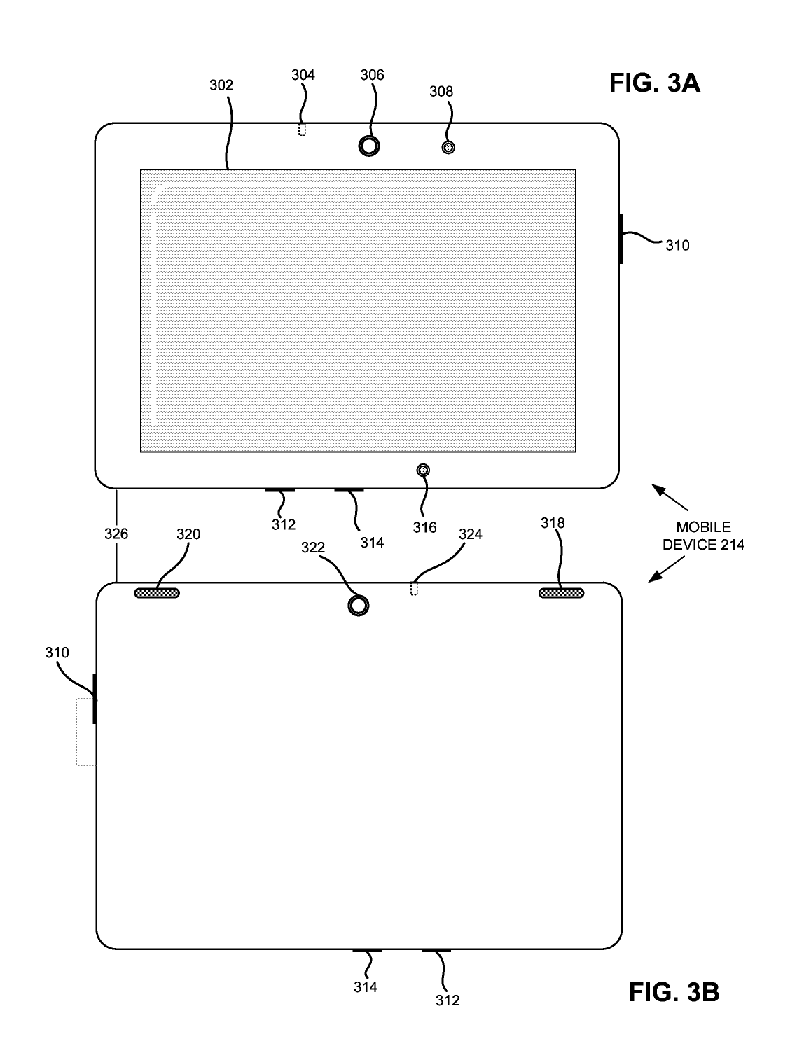

FIGS. 3A and 3B are, respectively, front and rear views of mobile device 214 according to one implementation. As shown in FIGS. 3A and 3B, mobile device 214 may include a display 302, a headset jack 304, a front camera 306, a notification indicator 308, power/sleep/volume key 310, a Universal Serial Bus (USB)/Power port 312, a high definition multimedia (HDMI) connector 314, a charging status indicator 316, speakers 318/320, a rear camera 322, a flash 324, and a housing 326. Depending on the implementation, mobile device 214 may include additional, fewer, different, or different arrangement of components than those illustrated in FIGS. 3A and 3B.

Display 302 may provide visual information to the user. In one implementation, an upgrade client installed on mobile device 214 may show the information via GUI. Headset jack 304 may include a plug into which one may attach speaker wires (e.g., headphone wires), so that electric signals from mobile device 214 can drive the speakers, to which the speaker wires run from headset jack 304.

Front camera 306 may enable the user to view, capture, store, and process images of a subject in/at front of mobile device 214. Notification indicator 308 may include a light emitting diode (LED) or another type of light source that blinks or turns on to indicate an incoming message (e.g., a text message, email, or call from upgrade support system 228).

Power/sleep/volume key 310 may allow the user to place device 214 in the power-savings (e.g., “sleep” mode). If mobile device 214 is already in the power-savings mode, triggering power sleep/volume key 310 may place device 214 in an active mode. In this particular implementation, power/sleep/volume 310 may also be used to increase or decrease speaker volume.

USB/Power port 312 may allow power to be received by mobile device 214, either from an adapter (e.g., an alternating current (AC) to direct current (DC) converter) or from another device (e.g., computer). HDMI connector 314 may allow mobile device 214 to output HDMI signals.

Charging status indicator 316 may include a lamp or an LED for indicating that mobile device 214 is being charged (e.g., charging status indicator 316 may blink or light up). Speakers 318/320 may provide audible information from mobile device 214 to a user/viewer of mobile device 214.

Rear camera 322 may enable the user to view, capture, store, and/or process images of a subject at the back of mobile device 214. Flash 324 may include a lamp or an LED for providing light for rear camera 322. Housing 326 may provide a casing for components of mobile device 214 and may protect the components from outside elements.

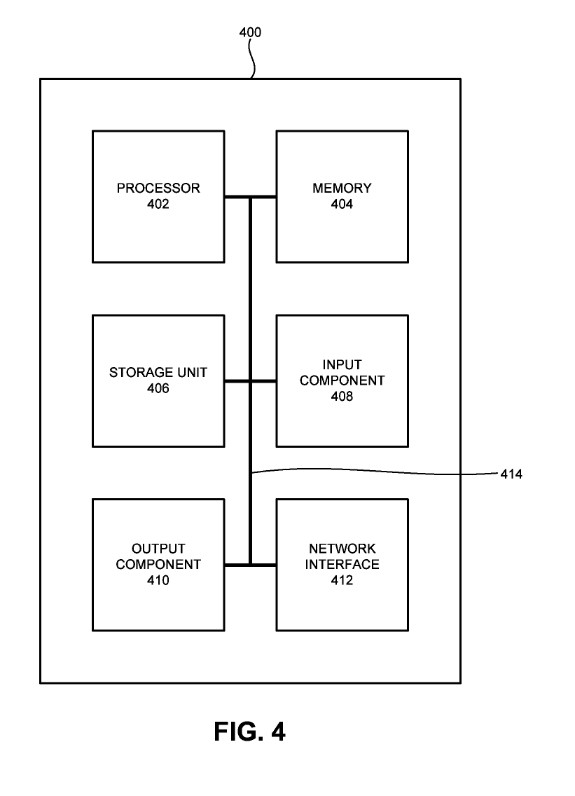

FIG. 4 is a block diagram of exemplary components of a network device 400 in network 200. Network device 400 may correspond to any of devices in FIG. 2A (e.g., mobile device 214, home computer 308, STB 208, etc.). As shown, network device 400 may include a number of components, namely: processor 402, memory 404, storage unit 406, input component 408, output component 410 and network interface 412, and communication path 414 interconnecting all of these components. In different implementations, network device 400 may include additional, fewer, different, or different arrangement of components than the ones illustrated in FIG. 4. For example, network device 400 may include line cards for connecting to external buses.

Processor 402 may include a processor, a microprocessor, an Application Specific Integrated Circuit (ASIC), a Field Programmable Gate Array (FPGA), and/or other processing logic (e.g., embedded devices) capable of controlling network device 400. Memory 404 may include static memory, such as read only memory (ROM), and/or dynamic memory, such as random access memory (RAM), or onboard cache, for storing data and machine-readable instructions (e.g., programs, scripts, etc.). Storage unit 406 may include a floppy disk, CD ROM, CD read/write (R/W) disc, and/or flash memory, as well as other types of storage devices (e.g., hard disk drive) for storing data and/or machine-readable instructions (e.g., a program, script, etc.). As used herein, the term “computer-readable medium” may include memory 404 or storage unit 406.

Input component 408 and output component 410 may provide input and output from/to a user to/from network device 400. Input/output components 408 and 410 may include a display screen, a keyboard, a mouse, a speaker, a microphone, a camera, a digital video disc or DVD reader, Universal Serial Bus (USB) lines, and/or other types of components for converting physical events or phenomena to and/or from signals that pertain to network device 400.

Network interface 412 may include a transceiver (e.g., a transmitter and a receiver) for network device 400 to communicate with other devices and/or systems. For example, via network interface 412, network device 400 may communicate over a network, such as the Internet, an intranet, a terrestrial wireless network (e.g., a WLAN, WiFi, WiMax, etc.), a satellite-based network, optical network, etc. Network interface 412 may include a modem, an Ethernet interface to a LAN, and/or an interface/connection for connecting network device 400 to other devices (e.g., a Bluetooth interface).

Communication path 414 may provide an interface through which components of network device 400 can communicate with one another.

Network device 400 may perform the operations described herein in response to processor 402 executing software instructions stored in a non-transient computer-readable medium, such as memory 404 or storage unit 406. The software instructions may be read into memory 404 from another computer-readable medium or from another device via network interface 412. The software instructions stored in memory 404 or storage unit 406, when executed by processor 402, may cause processor 402 to perform processes that are described herein.

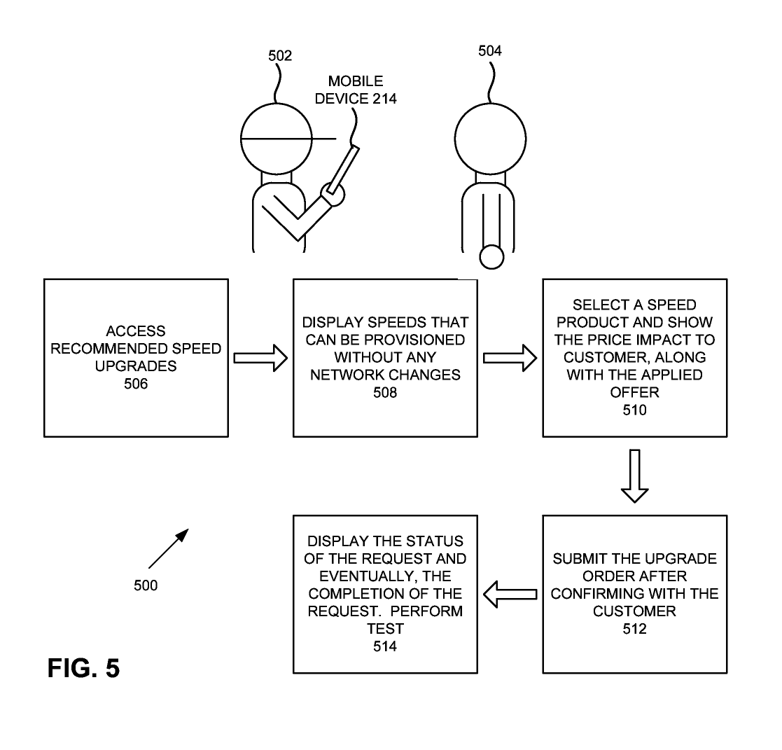

FIG. 5 is a flow diagram of an exemplary process 500 associated with upgrading communication speed/bandwidth according to one implementation. Assume that, during process 500, the user 502 is using mobile device 214 and is interacting with customer 504. As shown, process 500 may include accessing a list of recommended communication speed/bandwidth upgrades that are associated with a given service (e.g., the Internet service) (block 506). As discussed above, accessing the list of recommended upgrades may involve, by the user, activating a particular GUI component on the upgrade client installed on mobile device 214. In response, mobile device 214 may access information available on upgrade support system 228 and provide the list to the user for viewing.

Mobile device 214 may display a list of speeds that can be provisioned without any network changes (block 508). Based on the displayed speed upgrades and prices, the user may select a particular speed/bandwidth service (e.g., 3 Mbps Internet service) and discuss the speed/bandwidth service with the customer. That is, the user may show the price impact to the customer, along with the offer (block 510).

If the user confirms the upgrade (i.e., the user decides to purchase the upgrade), the user may submit the upgrade order via the upgrade client on mobile device 214 (block 512). The upgrade client may display the status of the order/request on the display of mobile device 214, and eventually, the completion of the request (block 514). The user may perform one or more tests to verify that the customer's product operates correctly at the required speed or the service is provided at the required speed (block 514).

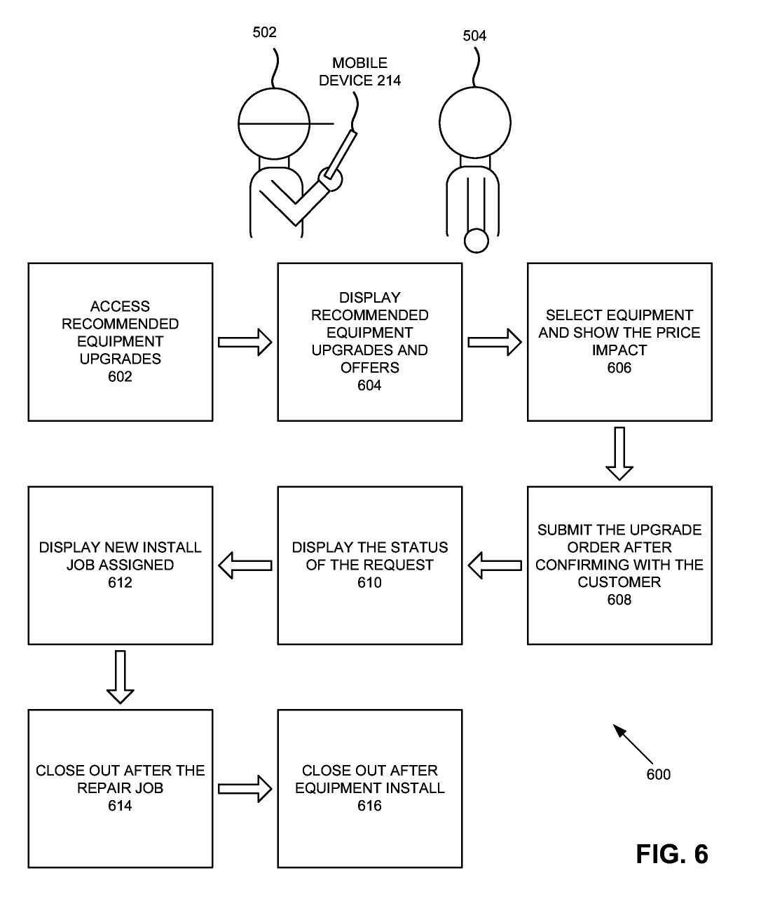

FIG. 6 is a flow diagram of an exemplary process 600 associated with upgrading a particular piece of equipment during repair work according to one implementation. As shown, process 600 may include accessing a list of recommended equipment upgrades (e.g., before performing repair work) (block 602). In a manner similar to that described above for FIG. 5, the upgrade client on mobile device 214 may display the list of recommended equipment upgrades and price impact (e.g., an improved set-top box or digital video recorder (DVR) and added cost of rental/purchase, etc.) (block 604). The user may offer an upgrade; select a particular piece of equipment for upgrade; and show the price impact (e.g., using mobile device 214), to the customer (block 606).

If the customer confirms that the customer wishes to upgrade the selected piece of equipment, the user may submit the upgrade order via mobile device 214 to upgrade support system 228 (block 608). When requested by the user, the upgrade client may display the status of the order/request (block 610).

Once the order has been submitted, upgrade support system 228 may assign a new installation task to the user and indicate, to the upgrade client on mobile device 214, that the installation task has been assigned to the user. The upgrade client may display information about the new installation task/job on mobile device 214 (block 612).

The user may perform and close out the required repair order (block 614). In addition, the user may install the upgraded equipment and close out the installation order (block 616).

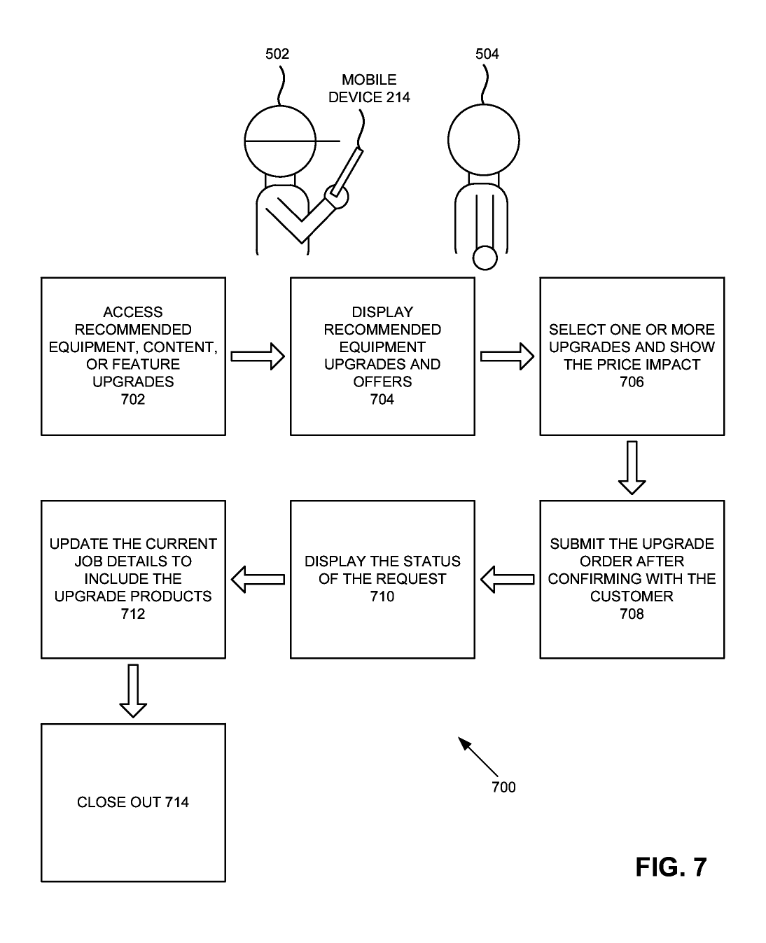

FIG. 7 is a flow diagram of an exemplary process 700 associated with upgrading a piece of equipment, features, or content service during an installation according to one implementation. As shown, the upgrade client on mobile device 214 may retrieve recommendations on equipment, content, and/or feature upgrade from upgrade support system 228 (block 702) and display information pertaining to the recommended upgrades (block 704).

The user may offer an upgrade; select a particular equipment, content, and/or feature for upgrade; and show the price impact (e.g., using mobile device 214), to the customer (block 706). If the customer decides to purchase the upgrade, the user may submit the order via mobile device 214 to upgrade support system 228 (block 708). When requested by the user, the upgrade client may display the status of the order (block 710).

The user may input the details of new job related to the upgrade into the upgrade client on mobile device 214. In response, the upgrade client may update database to record information relating the upgrade products and/or services (block 712). After performing any work related to the upgrade (e.g., installation, activation of features, testing, etc.), the user may close out the order (block 714).

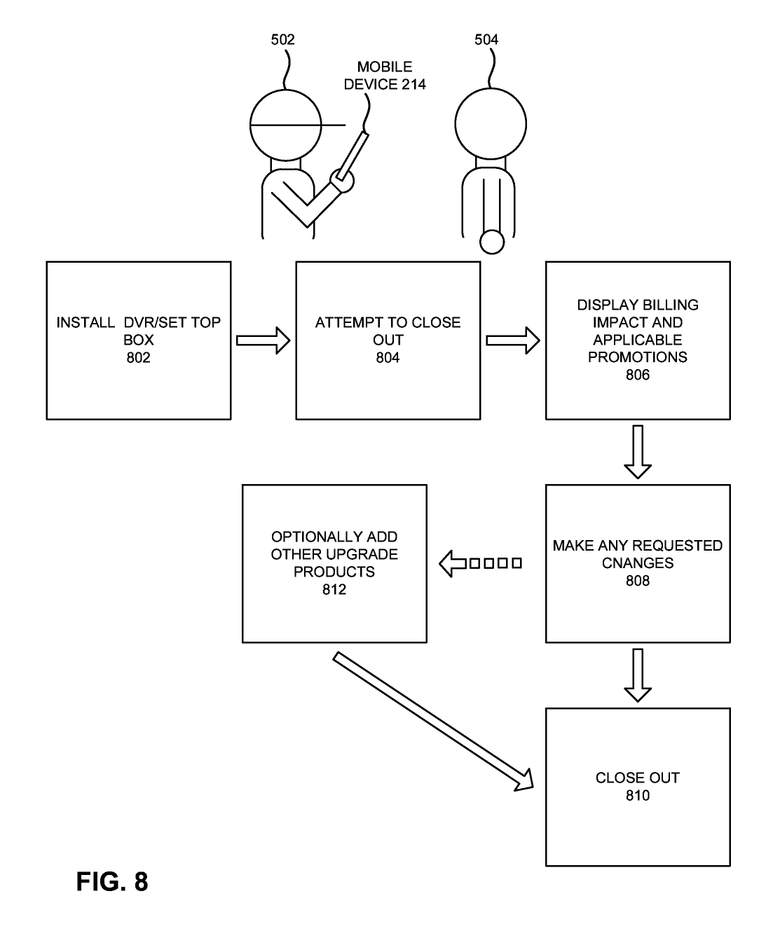

FIG. 8 is a flow diagram of an exemplary process 800 associated with an implicit upgrade according to one implementation. As shown, process 800 may include the user installing a DVR or a set-top box in customer premises 202 (block 802). Thereafter, the user may attempt to close out the order (block 804). During the attempt, the user may consult mobile device 214. The upgrade client installed on mobile device 214 may display applicable promotions and billing impact to the user (block 806).

Upon discussing the promotions and billing impact with the customer, the customer may request some changes, to which the user may comply (block 808). The user may then close out the order (block 810).

If the user determines that there are products/services that can/should be included in the upgrade, the user may add those products/services to the order (block 812). The user may then close out the order (block 810).

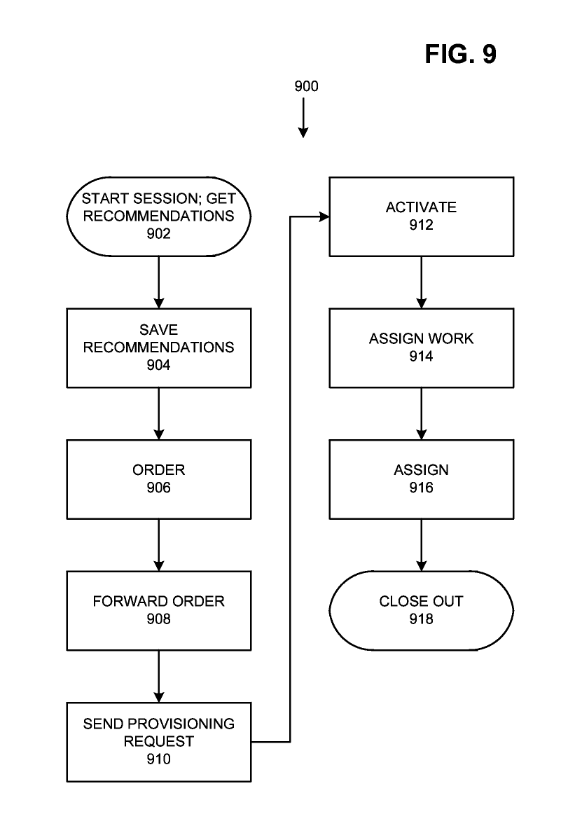

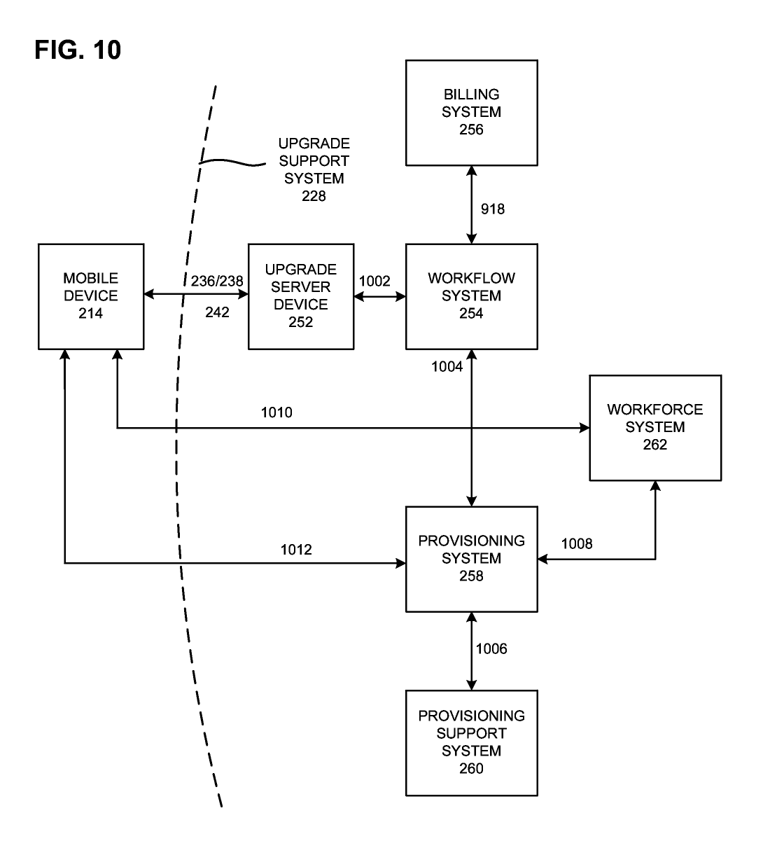

FIG. 9 is a flow diagram of an exemplary process 900 associated with upgrade support system 228. FIG. 10 is a diagram similar to that of FIG. 2C, but also illustrating function calls of FIG. 2B between the devices and/or components of upgrade support system 228 during process 900. As shown in FIG. 9, process 900 may include the upgrade client on mobile device 214 starting or establishing a session with upgrade server device 252 (block 902). When or after the session is established, the upgrade client may issue a Get Recommendations 236 in accordance with user input, as shown in FIG. 10 (block 902). Upgrade server device 252 may retrieve and provide a list of recommended upgrades to mobile device 214.

After discussing the recommendations with the customer, the user may select a particular, recommended upgrade product/service via mobile device 214. Accordingly, the upgrade client on mobile device 214 may issue on or more Save Recommendations 238 calls to upgrade server device 252 as illustrated in FIG. 10 (block 904 in FIG. 9). Upgrade server device 252 may save the selection(s).

To complete an upgrade, mobile device may issue Complete Order 242 to upgrade server device 252 (block 906). In response, upgrade server device 252 may forward or issue an order 1002 (FIG. 10) to workflow system 254 (block 908).

In response to order 1002, workflow system may generate and store a description of workflow or tasks that correspond to the order and that are to be performed by provisioning system 258. Thereafter, workflow system 254 may send one or more requests for provisioning (“a provisioning request”) 1004 (FIG. 10) to provisioning system 258 (block 910) in accordance with the workflow description.

When provisioning system 258 receives a provisioning request from workflow system 254, provisioning system 258 may issue a request 1006 to activate one or more devices, features (e.g., the ability to record more than 10 GB of content), content accessibility, etc., to provisioning support system 260. In response, provisioning support system 260 may activate the devices, features, and/or content accessibility (block 912). Depending on the situation, it is possible that provisioning system 258 does not issue a request to activate any devices, features, and/or content accessibility.

If the upgrade includes a new task order for the user, provisioning system 258 may also send one or more messages 1008 to workforce system 262. In such an instance, workforce system 262 may assign one or more tasks that are associated with the upgrade to the user, update one or more databases to record the assignment, and send a notification 1010, to mobile device 214 about the assignment (block 914). When the user receives notification 1010, the user may perform any required tasks assigned to the user, and close out the order (block 916). Depending on the implementation, the upgrade client on mobile device 214 may send a close out message to upgrade server device 252 or to provisioning system 258.

As described above, a user may install equipment, repair a device or network, and/or perform maintenance work at customer premises 202. Based on user input, mobile device 214 may determine what products and/or services may be upsold to the customer. If the customer wants to purchase an upgrade, the user may order the upgrade via mobile device 214, complete the tasks assigned to the user, and close out the tasks (e.g., installation). Upgrade support system 228 in communication with mobile device 214 may provide necessary support for facilitating the upgrade.

In this specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

In another example, while a series of blocks have been described with regard to exemplary processes illustrated in various figures, the order of the blocks in the figures may be modified in other implementations. In addition, non-dependent blocks may represent acts that can be performed in parallel to other blocks. Furthermore, one or more of the blocks may be omitted in other implementations.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

1. A method comprising:
initiating, at a device in a customer premises, a session with a remote system, wherein the remote system includes a network of a service provider, and wherein the device is associated with a representative of the service provider;
requesting, by the device in the customer premises, the remote system to provide a list of recommended upgrades for a customer during the session;
receiving, by the device in the customer premises, the list of recommended upgrades from the remote system;
selecting, by the device in the customer premises, at least one of the recommended upgrades in response to receiving the list of recommended upgrades;
sending an order, by the device in the customer premises to the remote system, for a product or a service associated with the selected upgrade;
receiving, by the device in the customer premises, a notification from the remote system responsive to the remote system processing the order, that a task has been assigned to a user of the device; and
closing out, by the device, the order based on input from the user indicating that the user performed the task.

2. The method of claim 1, wherein the device includes one of:
a laptop computer; a tablet computer; or a smart phone.

3. The method of claim 1, further comprising:
displaying the list of recommended upgrades in response to receiving the list from the remote system.

4. The method of claim 1, further comprising:
saving the list of recommended upgrades at the device in response to selecting the at least one of the list of recommended upgrades.

5. The method of claim 4, further comprising:
activating a feature, which is associated with the selected at least one of the recommended upgrades and a customer device in the customer premises, in response to receiving the notification at the user device.

6. A method comprising:
establishing, by a device associated with a service provider, a session with a user device in a customer premises over a network, wherein the user device is associated with a representative of the service provider;
receiving, from the user device in the customer premises during the session, a request to provide a list of recommended upgrades for a customer;
determining the list of recommended upgrades for the customer;
sending the list to the user device in the customer premises;
receiving an order for one of the recommended upgrades in the list from the user device in the customer premises; and
provisioning a product or service associated with the order from the user device in the customer premises.

7. The method of claim 6, wherein the list of recommended upgrades includes one of:
upgrading communication service bandwidth;
upgrading a piece of equipment; or
upgrading a service.

8. The method of claim 6, wherein receiving the order includes:
receiving the order to upgrade the product or service during repair work at the customer premises, and
wherein provisioning the product or service includes creating a new task in a database and assigning the new task to a user of the user device.

9. The method of claim 6, wherein receiving the order includes:
receiving the order to upgrade the product or service during an installation at the customer premises, and
wherein provisioning the product or service does not include creating a new task.

10. The method of claim 6, further comprising:
creating a description of workflow corresponding to the order;
storing the description in a database; and
using the stored description to generate one or more tasks for driving the provisioning a service or product.

11. The method of claim 6, further comprising:
obtaining the customer's history of using devices in a premises of the customer,
wherein determining the list of recommended upgrades includes:
determining the list of recommended upgrades based on the customer's history of using devices in the premises of the customer.

12. The method of claim 11, further comprising:
receiving a request to obtain a status of the order;
sending a reply describing the status of the order to the user device.

13. A system associated with a service provider, the system comprising:
an upgrade server device configured to:
establish a session with a user device in a customer premises over a network, wherein the user device is associated with a representative of the service provider;
receive, from the user device in the customer premises during the session, a request to provide a list of recommended upgrades for a customer;
obtain the list of recommended upgrades for the customer;
send the list to the user device in the customer premises;
receive, from the user device in the customer premises, an order for one of the recommended upgrades in the list; and
a provisioning system configured to:
provision a product or service associated with the order.

14. The system of claim 13, wherein the list of upgrades includes one of:
an increased communication service bandwidth;
a piece of upgraded equipment; or
an upgraded service.

15. The system of claim 13, wherein when receiving the order, the upgrade server device is further configured to:
receive the order to upgrade the product or service during repair work at the customer premises, and
wherein when the provisioning system provisions the product or service, the provisioning system is further configured to:
create a new task; and
assign the new task to a user of the user device.

16. The system of claim 13, wherein when receiving the order, the upgrade server device is further configured to:
receive the order to upgrade the product or service during an installation at the customer premises of the customer,
wherein when the provisioning system provisions the product or service, the provisioning system is configured to:
not create a new task for a user of the user device.

17. The system of claim 13, further comprising:
a workflow system configured to:
create a description of workflow corresponding to the order;
store the description; and
issue a request, to the provisioning system, to provision the product or service.

18. The system of claim 13, further comprising:
the user device,
wherein the user device includes a tablet computer.

19. The system of claim 13, wherein the system is configured to:
receive a request to obtain a status of the order; and
send a reply describing the status of the order to the user device.

20. The system of claim 13, wherein the upgrade server device is further configured to:
receive a notification, from the user device, for closing out the order.
